(19) United States
(12) Patent Application Publication
(10) Pub. No.: US 2025/0060007 A1
(43) Pub. Date: Feb. 20, 2025

(54) ADAPTABLE BUSHING ASSEMBLY REMOVAL COUPLER AND SYSTEMS AND METHODS FOR REMOVING BUSHING ASSEMBLIES

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford, BC (CA)

(21) Appl. No.: 18/801,221

(22) Filed: Aug. 12, 2024

Related U.S. Application Data
(60) Provisional application No. 63/519,426, filed on Aug. 14, 2023.

(51) Int. Cl. F16C 43/02; B23P 15/00

(52) U.S. Cl. CPC F16C 43/02; B23P 15/003

(57) ABSTRACT

A coupler assembly for engaging a bushing pin of a bushing assembly, the bushing pin defining a bushing pin first end portion, a bushing pin middle portion, and a bushing pin second end portion. The coupler assembly comprises a pull rod assembly adapted to be detachably attached to the bushing pin first end portion and a cap assembly comprising a cap member and an adapter member. The cap member is adapted to be detachably attached to the bushing pin second portion. The adapter member is configured to be arranged over at least a portion of the bushing pin second portion. The adapter member and the cap member are configured such that, when the cap member is detachably attached to the bushing pin second portion, the adapter member may be arranged between the cap member and the bushing pin middle portion to transfer movement of the cap member to the bushing assembly.

### RELATED APPLICATIONS

This application (Attorney's Ref. No. P220548) claims benefit of U.S. Provisional Application Ser. No. 63/519,426 filed Aug. 14, 2023, the contents of which are incorporated herein by reference.

### TECHNICAL FIELD

The present invention relates to adaptable bushing assembly removal couplers and to systems and methods for removing bushing assemblies from structural members.

### BACKGROUND

Bushing assemblies typically comprise a bushing housing, a bushing sleeve arranged within the bushing housing, and a bushing pin arranged within the bushing sleeve. Maintenance and/or repair of a bushing assembly often requires removal of the bushing assembly from a structural member. A removal force must be applied on the bushing assembly relative to the structural member to displace the bushing assembly relative to the bushing housing.

Bushing assemblies come in a variety of sizes, shapes, and configurations. The need exists for bushing assembly removal systems and methods that facilitate the removal of bushing assemblies of different sizes, shapes, and configurations.

### SUMMARY

The present invention may be embodied as a coupler assembly for engaging a bushing pin of a bushing assembly, the bushing pin defining a bushing pin first end portion, a bushing pin middle portion, and a bushing pin second end portion. The coupler assembly comprises a pull rod assembly adapted to be detachably attached to the bushing pin first end portion and a cap assembly comprising a cap member and an adapter member. The cap member is adapted to be detachably attached to the bushing pin second portion. The adapter member is configured to be arranged over at least a portion of the bushing pin second portion. The adapter member and the cap member are configured such that, when the cap member is detachably attached to the bushing pin second portion, the adapter member may be arranged between the cap member and the bushing pin middle portion to transfer movement of the cap member to the bushing assembly.

The present invention may also be embodied as a method of coupling a pull rod to a bushing pin of a bushing assembly. The bushing pin defines a bushing pin first end portion, a bushing pin middle portion, and a bushing pin second end portion. The method comprises the steps of detachably attaching a pull rod to the bushing pin first end portion and providing a cap assembly comprising a cap member adapted to be detachably attached to the bushing pin second portion and an adapter member configured to be arranged over at least a portion of the bushing pin second portion. The cap member is detachably attached to the bushing pin second portion such that the adapter member is arranged between the cap member and the bushing pin middle portion to transfer movement of the cap member to the bushing assembly.

The present invention may further be embodied as a coupler assembly for engaging a bushing pin of a bushing assembly. The bushing pin defines a bushing pin first end portion defining a first bushing pin opening, a bushing pin middle portion, and a bushing pin second end portion defining a second bushing pin opening. The coupler assembly comprises a pull rod assembly and a cap assembly. The pull rod assembly comprises a pull rod, an anchor assembly, and a pull rod pin. The pull rod pin is adapted to extend through at least a portion of the anchor assembly and the first bushing pin opening to detachably attach the pull rod to the bushing pin first end portion. The cap assembly comprises a cap member, an adapter member, and a cap pin. The cap member is adapted to be detachably attached to the bushing pin second portion. The adapter member configured to be arranged over at least a portion of the bushing pin second portion. The cap pin is configured to extend at least partly through the cap member and at least partly through the bushing pin second end opening to detachably attach the cap member to the bushing pin second end portion. The adapter member and the cap member are configured such that, when the cap member is detachably attached to the bushing pin second portion, the adapter member may be arranged between the cap member and the bushing pin middle portion to transfer movement of the cap member to the bushing assembly.

### BRIEF DESCRIPTION OF THE DRAWINGS

FIG. 1 is a perspective view of a first example coupler assembly for removing a bushing assembly;

FIG. 2 is an exploded view of the first example coupler assembly;

FIG. 3 is a top partial section view illustrating the connection of the first example coupler assembly to a first example bushing assembly supported by a structural member;

FIG. 4 is a side partial section view illustrating the connection of the first example coupler assembly to the first example bushing assembly supported by a structural member;

FIG. 5 is a side section view illustrating the connection of the first example coupler assembly to the first example bushing assembly supported by a structural member;

FIG. 6 is a top section view illustrating the connection of the first example coupler assembly to the first example bushing assembly supported by a structural member;

FIG. 7 is a front perspective view of a first example cap assembly of the first example coupler assembly;

FIG. 8 is a rear perspective view of the first example cap assembly of the first example coupler assembly;

FIG. 9 illustrates a first example adapter plate of the first example cap assembly;

FIG. 10 illustrates a second example adapter plate that may be used as part of a second example cap assembly;

FIG. 11 illustrates a third example adapter plate that may be used as part of a third example cap assembly; and

FIGS. 12-17 illustrate an example system and method for removing the first example bushing assembly using the first example coupler assembly.

### DETAILED DESCRIPTION

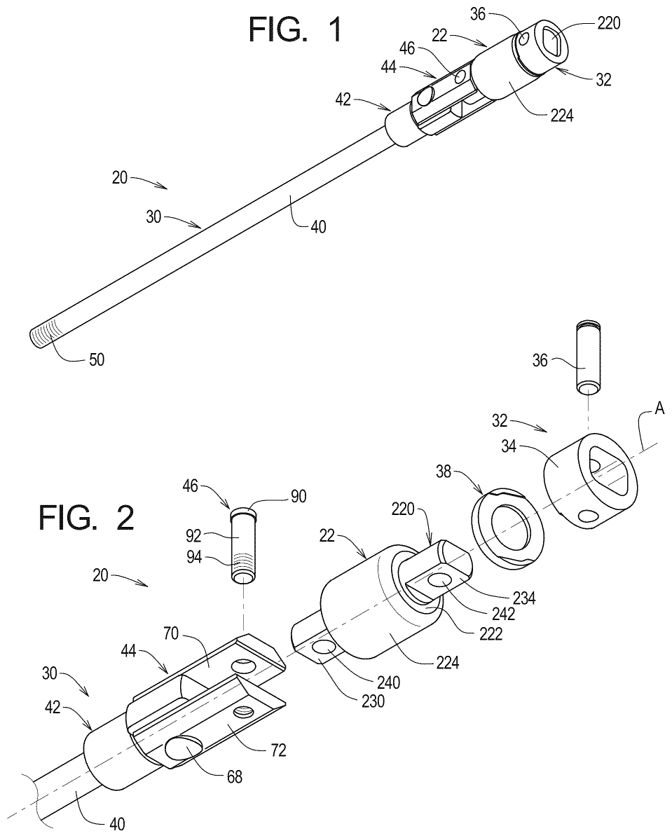

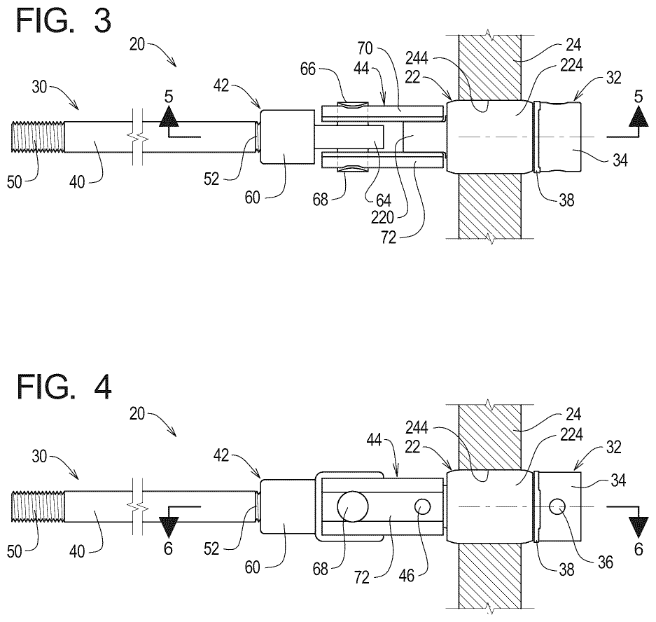

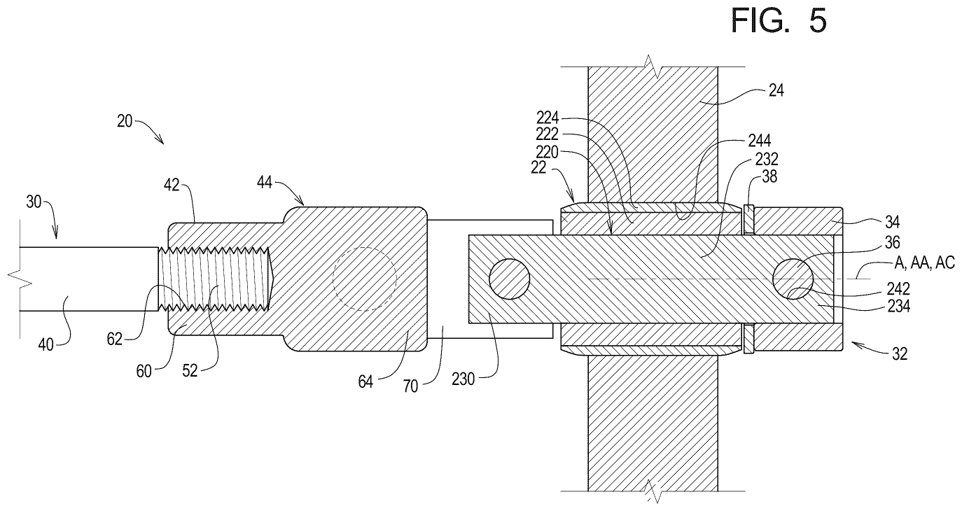

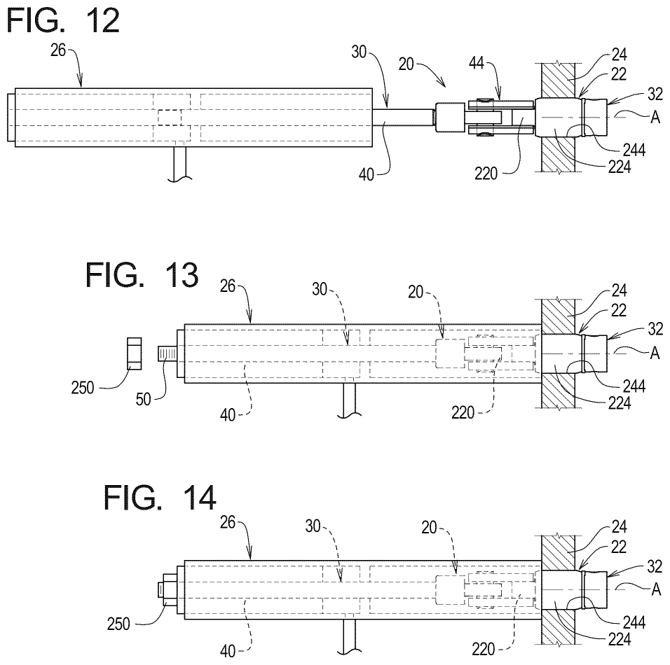

Referring initially to FIGS. 1-8 of the drawing, depicted therein is a first example coupler assembly 20 of the present invention. FIGS. 2-6 further illustrate a first example bushing assembly 22 to be removed from an example structural member 24 (FIGS. 3-6) using the first example coupler assembly 20. FIGS. 12-17 illustrate the use of an example actuator system 26 and the first example coupler assembly 20 to remove the first example bushing assembly 22 from the example structural member 24. The example bushing assembly 22, the example structural member 24, and the example actuator system 26 are or may be conventional and are depicted and described herein to that extent helpful to a full understanding of the construction and operation of the present invention.

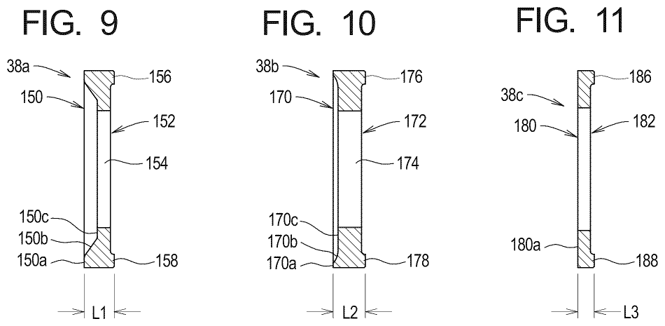

The first example coupler assembly 20 comprises a pull rod assembly 30 and a cap assembly 32. The example cap assembly 32 comprises a cap member 34, a cap pin 36, and, optionally, at least one adapter member 38. FIGS. 9-11 illustrate first, second, and third example adapter plates 38a, 38b, and 38c that may be used, alone or in combination, as the adapter member 38 of the cap assembly 32 of the present invention. In FIGS. 1-8 and 12-17, the first example adapter plate 38a is used as the adapter member 38. In use, the pull rod assembly 30 is connected to one end of the bushing assembly 22 and the cap assembly 32 is connected to a second end of the bushing assembly 22. The example actuator system 26 is then operated to displace the pull rod assembly 30 relative to the structural member 24 such that the pull rod assembly displaces the bushing assembly 22 and the bushing assembly 22 in turn displaces the cap assembly 32 such that the entire bushing assembly 22 is displaced relative to the structural member 24. One or both of the second and third adapter plates 38b and 38c may be used in substantially the same manner as the first example adapter plate 38a to pull bushing assemblies having sizes, shapes, and configurations that differ from that of the first example coupler assembly 22.

With the foregoing general understanding of the construction and operation of the present invention in mind, the details of construction and operation of the first example coupler assembly 20 and an example system and method for removing bushing assemblies such as the example bushing assembly 22 will now be described in further detail.

As perhaps best shown in FIGS. 1-6, the example pull rod assembly 30 comprises a pull rod 40, a pull rod connecting member 42, an anchor assembly 44, and a pull rod pin 46. The example pull rod 40 defines actuator and anchor threaded ends 50 and 52. The pull rod connecting member 42 has a base portion 60 defining a threaded cavity 62 and an extension portion 64 defining first and second anchor projections 66 and 68. The actuator threaded end 50 is adapted to engage the displacement assembly 26 such that operation of the displacement assembly causes displacement of the pull rod along a longitudinal axis A of the pull rod 40. The anchor threaded end 52 is adapted to engage the threaded cavity 62 in the base portion 60 of the connecting member 42 such that movement of the pull rod 40 along the pull rod axis A displaces the connecting member 42 along the pull rod axis A.

The example anchor assembly 44 comprises first and second anchor plates 70 and 72 and first and second retainer clips 74 and 76. The first anchor plate 70 defines first anchor plate anchor and pin openings 80 and 82, and the second anchor plate 72 defines second anchor plate anchor and pin openings 84 and 86.

The anchor plate anchor openings 80 and 84 are through holes adapted to receive the first and second anchor projections 66 and 68, respectively. The first and second retainer clips 74 and 76 are arranged to engage the anchor projections 66 and 68 and/or anchor plates 70 and 72 to inhibit movement of the anchor plates 70 and 72 in directions orthogonal to the pull rod axis A relative to the pull rod connecting member 42.

The pin opening 82 of the first anchor plate 70 defines inner and outer pin opening portions 82a and 82b, with a cross-sectional area of the outer pin opening 82b being greater than that of the inner pin opening 82a. The pin opening 84 of the second anchor plate 72 is threaded.

The example pull rod pin 46 defines a head portion 90, a shaft portion 92, and a threaded end portion 94. The head portion 90 is sized and dimensioned to be received within the outer pin opening portion 82b. The shaft is adapted to extend through the inner pin opening portion 82a in the first anchor plate 70. The threaded end portion 94 is adapted to engage the pin opening 86 in the second anchor plate 72. With the head portion 90 arranged within outer pin opening portion 82b in the first anchor plate 70 and the threaded end portion 94 of the pull rod pin 46 threaded into the pin opening 86 in the second anchor plate 72, the pull rod pin 46 is detachably attached to the first and second anchor plates 70 and 72. A distance between the first and second anchor plates 70 and 72 is configured to accommodate a cross-sectional area of a portion of the example bushing assembly 22 as will be described in further detail below.

With the anchor projections 66 and 68 arranged within the anchor openings 80 and 84 and the pull rod pin 46 detachably attached to the first and second anchor plates 70 and 72, movement of the connecting member 42 along the pull rod axis A displaces the anchor plates 70 and 72 and the pull rod pin 46 along the pull rod axis A.

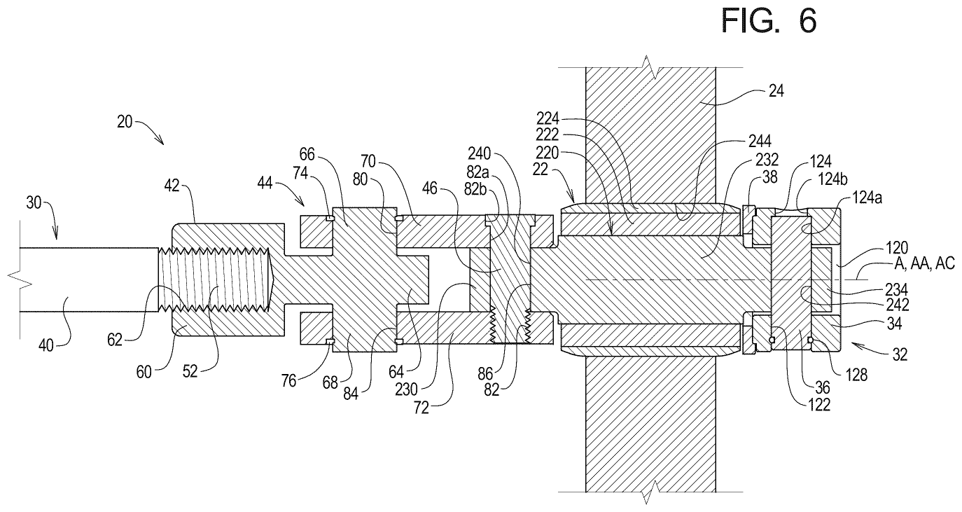

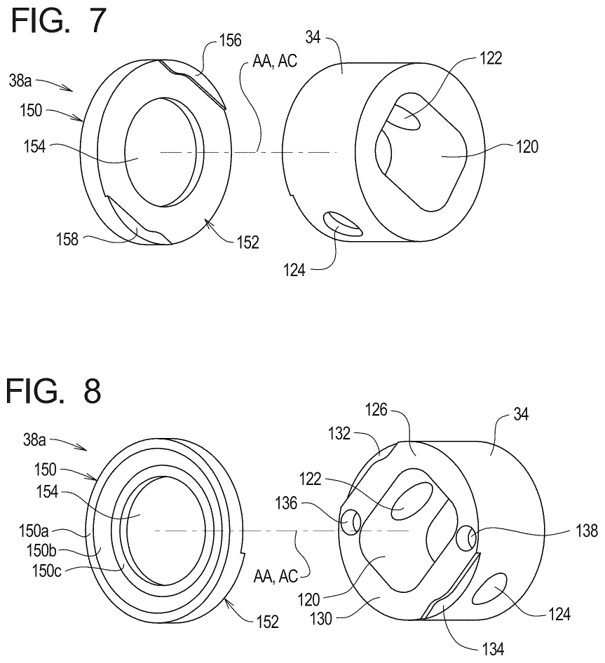

Referring now to FIGS. 7-11 of the drawing, the example cap assembly 32 will now be described in further detail. The example cap member 34 defines a primary opening 120, first and second secondary openings 122 and 124, and a cap intermediate end 126. As shown in FIGS. 7 and 8, the example intermediate end 126 defines a cap intermediate surface 130, first and second key recesses 132 and 134, and first and second intermediate openings 136 and 138. The example cap member 34 defines a cap axis AC extending through the primary opening 120. The example primary opening 120 is sized and dimensioned to receive at least a portion of part of the bushing assembly 20 as will be described in further detail below. The example secondary openings 122 and 124 are sized and dimensioned to receive portions of the cap pin 36 such that a portion of the cap pin 36 extends through the primary opening 120. The example second secondary opening 124 comprises an inner secondary opening portion 124a and an outer secondary opening outer portion 124b as best shown in FIG. 6.

The example adapter plate 38a defines an engaging side 150, an adapter intermediate side 152, and an adapter plate opening 154 extending between the engaging and adapter intermediate sides 150 and 152. Extending from the example adapter intermediate side 152 are first and second key projections 156 and 158 adapted to engage the key recesses 132 and 134 as will be described in further detail below. The example adapter plate 38a further defines an adapter axis AA extending through the adapter plate opening 154. The example adapter plate opening 154 is sized and dimensioned to receive at least a portion of part of the bushing assembly 22 as will be described in further detail below. The example adapter plate engaging side 150 is contoured or otherwise shaped to engage the bushing assembly 22. In particular, the example adapter plate engaging side 150 comprises a rim surface 150a, an angled surface 150b, an inner annular surface 150c, and a length L1.

The second and third example adapter plates 38b and 38c perform a similar function but are different in size, configuration, and shape than each other and the first example adapter plate 38a.

In particular, the second example adapter plate 38b defines an engaging side 170, an adapter intermediate side 172, and an adapter plate opening 174 extending between the engaging and adapter intermediate sides 170 and 172. Extending from the example adapter intermediate side 172 are first and second key projections 176 and 178 adapted to engage the key recesses 132 and 134 as will be described in further detail below. The example adapter plate engaging side 170 is contoured or otherwise shaped to engage a bushing assembly having different size, configuration, and dimensions than the example bushing assembly 22. In particular, the example adapter plate engaging side 170 comprises a rim surface 170a, an angled surface 170b, and an inner annular surface 170c, and length L2 that is different from those corresponding features of the first example adapter plate 38a.

The third example adapter plate 38c defines an engaging side 180, an adapter intermediate side 182, and an adapter plate opening 184 extending between the engaging and adapter intermediate sides 180 and 182. Extending from the example adapter intermediate side 182 are first and second key projections 186 and 188 adapted to engage the key recesses 132 and 134 as will be described in further detail below. The example adapter plate engaging side 180 is contoured or otherwise shaped to engage a bushing assembly having different size, configuration, and dimensions than the example bushing assembly 22. In particular, the example adapter plate engaging side 180 defines a flat engaging surface 180a and a length L3 that is different from those corresponding features of the first example adapter plate 38a or of the second example adapter plate 38b. The user selects one or more of the first, second, and third adapter plates 38a, 38b, and 38c as appropriate for a particular bushing assembly being displaced.

The example cap pin 36 is generally cylindrical and is sized and dimensioned to be received within the first secondary opening 122 and the inner secondary opening portion 124a of the second secondary opening 124. A diameter of the outer secondary opening portion 124a of the secondary opening 124 is reduced relative to a diameter of the inner secondary opening portion 124a such that the cap pin 36 cannot be displaced entirely through the second secondary opening 124. A retaining member 128 may be arranged to inhibit movement of the cap pin 36 relative to the cap member 34 when the example cap pin 36 is within the first and second secondary openings as described above. The example retaining member 128 may be, for example, a resilient O-ring, arranged on the example cap pin 36 to frictionally engage both the cap pin 36 and the cap member 34.

Referring for a moment back to FIGS. 1-6, the example bushing assembly 22 will now be described in further detail. The example bushing assembly 22 comprises a bushing pin 220, a bushing sleeve 222, and a bushing housing 224. The bushing pin 220 comprises a first end portion 230, a middle portion 232, and a second end portion 234. A first bushing pin opening or recess 240 is formed in the first end portion 230, and a second bushing pin opening 242 is formed in the second end portion 234. To assemble the bushing assembly 22, the bushing sleeve 222 is arranged around middle portion 232 of the bushing pin 220, and the bushing housing 224 is arranged around the bushing sleeve 222. So assembled, the first and second end portions 230 and 234 extend out of the bushing housing 224. When used, the bearing assembly 22 is arranged within a structural opening 244 defined by the structural member 24.

Use the first example coupler assembly 20 assembled as generally described above will now be described. Initially, as shown in FIGS. 3-6, the first end portion 230 of the bushing pin 220 is arranged between the anchor plates 70 and 72 such that the first bushing pin opening or recess 240 is substantially aligned with the first and second anchor pin openings 82 and 86 as shown in FIGS. 3-6. The pull rod pin 46 is then inserted through the first anchor pin opening 82 and at least partly or entirely through the first bushing pin opening or recess 240 to connect the example coupler assembly to the first end portion 230 of the bushing pin 220. If the pull rod pin 46 is inserted entirely through the first bushing pin opening or recess 240, the pull rod pin 46 may further be threaded into the second anchor pin opening 86 to connect the example coupler assembly to the first end portion 230 of the bushing pin 220.

The example cap assembly 32 is next connected to the second end portion 232 of the bushing pin 220 as also shown in FIGS. 3-6. Initially, the example adapter plate 38a is displaced such that the second end portion 232 of the bushing pin 220 passes through the adapter plate opening 154 with the adapter engaging side 150 facing the bushing sleeve 222 and the bushing housing 224 and the adapter intermediate side 152 facing away from the bushing assembly 22. The example cap member 34 is next displaced such that the second end portion 234 of the bushing pin 220 passes through the primary opening 120 with the cap intermediate end 126 facing the adapter intermediate side 152 and the key projections 156 and 158 received within the key recesses 132 and 134. The example primary opening 120 is sized and dimensioned to snugly fit around the second end portion 234 of the bushing pin 220. The cap member 34 is further displaced until the secondary openings 122 and 124 are aligned with the second bushing pin opening 242.

The cap pin 36 is then displaced through the first secondary opening 122, through the bushing pin opening 242, and into the inner secondary opening portion 124a until the outer secondary portion 124b stops further movement of the cap pin 36. The optional retaining member 128 frictionally engages the cap pin 36 and the cap member 34 to inhibit removal of the cap pin 36 from the secondary openings 122 and 124.

At this point, as shown in FIGS. 3-6, the cap assembly 32 is detachably attached to the second end portion 234 of the bushing pin 220 with the axes AC and AA substantially aligned with the axis A and the example rim surface 150 is arranged to apply substantially even pressure on the bushing sleeve 222 and the bushing housing 224 when the bushing pin 220 is displaced as will be described in further detail below.

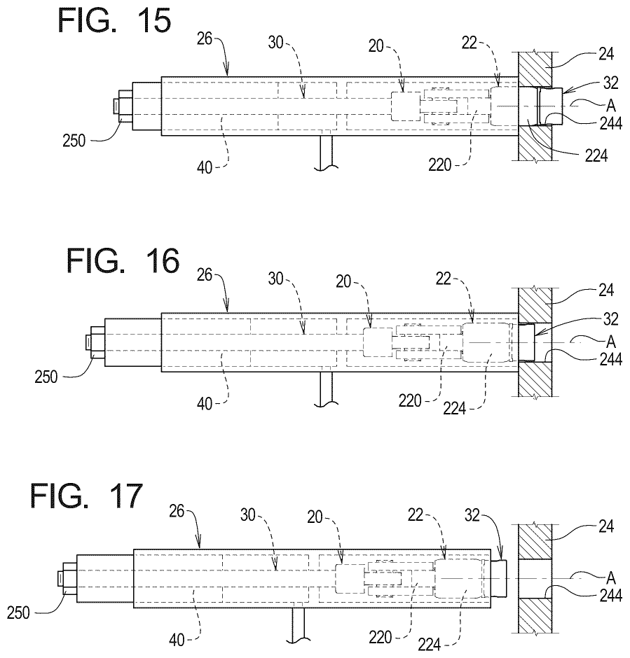

Next, the actuator end 50 of the pull rod 40 is inserted into and through the actuator system 26 (FIG. 12) and then secured relative to the actuator system 26 using an actuator nut 250 (FIGS. 13 and 14). With the actuator system 26 braced against the structural member 24, operation of the actuator system 26 displaces the pull rod 40 as shown in FIGS. 15-17 displaces the bushing assembly 22 relative to the structural member 24. During operation of the actuator system 26, the pull rod assembly 30 displaces the bushing pin 220, while the cap assembly 32 displaces the bushing sleeve 222 and the bushing housing 224 substantially in tandem with the bushing pin 220. The bushing assembly 22 may thus be removed from the structural member 24 substantially intact. The bushing assembly 22 may then be removed from the first example coupler assembly 20 by removing the pull rod pin 46 and the cap pin 36.

What is claimed is:

1. A coupler assembly for engaging a bushing pin of a bushing assembly, the bushing pin defining a bushing pin first end portion, a bushing pin middle portion, and a bushing pin second end portion, the coupler assembly comprising:
a pull rod assembly adapted to be detachably attached to the bushing pin first end portion; and
a cap assembly comprising
a cap member adapted to be detachably attached to the bushing pin second portion, and
an adapter member configured to be arranged over at least a portion of the bushing pin second portion; wherein
the adapter member and the cap member are configured such that, when the cap member is detachably attached to the bushing pin second portion, the adapter member may be arranged between the cap member and the bushing pin middle portion to transfer movement of the cap member to the bushing assembly.

2. A coupler assembly as recited in claim 1, in which the adapter member defines an adapter plate engaging side configured to engage the bushing assembly.

3. A coupler assembly as recited in claim 1, in which the adapter member defines an adapter plate length configured to transfer movement of the cap member to the bushing assembly.

4. A coupler assembly as recited in claim 1, in which the adapter member defines an adapter plate intermediate side configured to engage the cap member.

5. A coupler assembly as recited in claim 1, in which:
the cap member defines at least one cap member key surface; and
the adapter plate defines at least one adapter plate key surface; wherein
the at least one cap member key surface is configured to engage the at least one adapter plate key surface such that the adapter plate is in a desired orientation relative to the cap member when the adapter member transfers movement of the cap member to the bushing assembly.

6. A coupler assembly as recited in claim 5, in which:
the cap member defines at least one cap member recess defining the at least one cap member key surface; and
the adapter plate defines at least one adapter plate key projection defining the at least one adapter plate key surface; wherein
the at least one cap member key recess is configured to receive the at least one adapter plate key projection such that the adapter plate is in the desired orientation relative to the cap member.

7. A coupler assembly as recited in claim 1, in which the cap assembly further comprises a cap pin configured to extend at least partly through the cap member and at least partly through the bushing pin second end portion to detachably attach the cap member to the bushing pin second end portion.

8. A coupler member as recited in claim 1, in which the pull rod assembly comprises:
a pull rod; and
an anchor assembly; wherein
the pull rod is operatively connected to the anchor assembly such that movement of the pull rod is transferred to the anchor assembly; and
the anchor assembly is adapted to be detachably attached to the bushing pin second end portion such that movement of the anchor assembly is transferred to the bushing pin first end portion.

9. A coupler member as recited in claim 8, in which the pull rod assembly further comprises a pull rod pin configured to extend at least partly through the anchor assembly and at least partly through the bushing pin first end portion to detachably attach the anchor assembly to the bushing pin first end portion.

10. A method of coupling a pull rod to a bushing pin of a bushing assembly, the bushing pin defining a bushing pin first end portion, a bushing pin middle portion, and a bushing pin second end portion, the method comprising the steps of:
detachably attaching a pull rod to the bushing pin first end portion; and
providing a cap assembly comprising
a cap member adapted to be detachably attached to the bushing pin second portion, and
an adapter member configured to be arranged over at least a portion of the bushing pin second portion; wherein
detachably attaching the cap member to the bushing pin second portion such that the adapter member is arranged between the cap member and the bushing pin middle portion to transfer movement of the cap member to the bushing assembly.

11. A method as recited in claim 10, in which the step of providing the cap assembly comprises the step of configuring the adapter member to define an adapter plate engaging side configured to engage the bushing assembly.

12. A method as recited in claim 10, in which the step of providing the cap assembly comprises the step of configuring the adapter member to define an adapter plate length configured to transfer movement of the cap member to the bushing assembly.

13. A method as recited in claim 10, in which the step of providing the cap assembly comprises the step of configuring the adapter member to define an adapter plate intermediate side configured to engage the cap member.

14. A coupler assembly for engaging a bushing pin of a bushing assembly, the bushing pin defining a bushing pin first end portion defining a first bushing pin opening, a bushing pin middle portion, and a bushing pin second end portion defining a second bushing pin opening, the coupler assembly comprising:
a pull rod assembly comprising a pull rod, an anchor assembly, and a pull rod pin adapted to extend through at least a portion of the anchor assembly and the first bushing pin opening to detachably attach the pull rod to the bushing pin first end portion; and
a cap assembly comprising
a cap member adapted to be detachably attached to the bushing pin second portion,
an adapter member configured to be arranged over at least a portion of the bushing pin second portion, and
a cap pin configured to extend at least partly through the cap member and at least partly through the bushing pin second end opening to detachably attach the cap member to the bushing pin second end portion; wherein
the adapter member and the cap member are configured such that, when the cap member is detachably attached to the bushing pin second portion, the adapter member may be arranged between the cap member and the bushing pin middle portion to transfer movement of the cap member to the bushing assembly.

15. A coupler assembly as recited in claim 14, in which the adapter member defines an adapter plate engaging side configured to engage the bushing assembly.

16. A coupler assembly as recited in claim 14, in which the adapter member defines an adapter plate length configured to transfer movement of the cap member to the bushing assembly.

17. A coupler assembly as recited in claim 14, in which the adapter member defines an adapter plate intermediate side configured to engage the cap member.

18. A coupler assembly as recited in claim 14, in which:
the cap member defines at least one cap member key surface; and
the adapter plate defines at least one adapter plate key surface; wherein
the at least one cap member key surface is configured to engage the at least one adapter plate key surface such that the adapter plate is in a desired orientation relative to the cap member when the adapter member transfers movement of the cap member to the bushing assembly.

19. A coupler assembly as recited in claim 18, in which:
the cap member defines at least one cap member recess defining the at least one cap member key surface; and
the adapter plate defines at least one adapter plate key projection defining the at least one adapter plate key surface; wherein
the at least one cap member key recess is configured to receive the at least one adapter plate key projection such that the adapter plate is in the desired orientation relative to the cap member.
